(19) United States
(12) Patent Application Publication
(10) Pub. No.: US 2014/0174946 A1
(43) Pub. Date: Jun. 26, 2014

(54) SYSTEM AND METHOD FOR ESTIMATING IMPEDANCE IN ELECTROCHEMICAL IMPEDANCE SPECTROSCOPY

(71) Applicants: King Fahd University of Petroleum and Minerals, (US); KING ABDULAZIZ CITY FOR SCIENCE AND TECHNOLOGY, Riyadh (SA)

(72) Inventors: AHMED MOHAMED YAMANI, ALGIERS (DZ); SAEED OMAR SAEED ALJABRI, AL-KOHBAR (SA)

(73) Assignees: KING ABDULAZIZ CITY FOR SCIENCE AND TECHNOLOGY, RIYADH (SA); KING FAHD UNIVERSITY OF PETROLEUM AND MINERALS, DHAHRAN (SA)

(21) Appl. No.: 13/727,527

(22) Filed: Dec. 26, 2012

(51) Int. Cl. G01N 27/04

(52) U.S. Cl. CPC G01N 27/04
USPC 205/776.5

(57) ABSTRACT

The method for estimating impedance in electrochemical impedance spectroscopy is an iterative method, combining high order statistic (HOS) deconvolution and adaptive filtering (AF) to estimate impedance in electrochemical impedance spectroscopy for such applications as measuring the degree of electrolytic corrosion in a coated metal pipe, for example.

### BACKGROUND OF THE INVENTION

1. Field of the Invention

The present invention relates generally to electrochemistry, and particularly to a system and method for estimating impedance in electrochemical impedance spectroscopy based on high order statistic (HOS) deconvolution and adaptive filtering (AF).

2. Description of the Related Art

Electrochemical impedance spectroscopy (EIS) is a technique for measuring the dielectric properties of a medium as a function of frequency. EIS is based on the interaction of an external field with the electric dipole moment of the sample, which is often expressed by permittivity. EIS is also an experimental method of characterizing electrochemical systems. This technique measures the impedance of a system over a range of frequencies. Therefore, the frequency response of the system, including the energy storage and dissipation properties, is revealed. Impedance is the opposition to the flow of alternating current (AC) in a complex system. A passive complex electrical system includes both energy dissipater (i.e., a resistor) and energy storage (i.e., a capacitor) elements. If the system is purely resistive, then the opposition to AC or direct current (DC) is simply resistance.

Two primary techniques are used in EIS, namely, frequency domain methods and time domain methods. The frequency response analyzer (FRA) technique is one example of the frequency domain methods. The FRA technique gives reliable impedance measurements, but at the expense of long acquisition time, cost and complexity. Thus, the FRA is not typically seen to be applicable to real-time applications. On the other hand, Fast Fourier Transform (FFT) based methods, which belong to the time domain techniques, are much faster than the FRA, but with a tradeoff of less reliability and accuracy due to an inherent dynamic range deficiency. Thus, it would be desirable to provide a relatively simple and fast EIS technique that will produce reliable impedance data in a noisy environment.

Thus, a system and method for estimating impedance in electrochemical impedance spectroscopy solving the aforementioned problems is desired.

### SUMMARY OF THE INVENTION

The method for estimating impedance in electrochemical impedance spectroscopy is an iterative method, combining high order statistic (HOS) deconvolution and adaptive filtering (AF) to estimate impedance in electrochemical impedance spectroscopy for such applications as measuring the degree of electrolytic corrosion in a coated metal pipe, for example.

The method for estimating impedance in electrochemical impedance spectroscopy includes the following steps: (a) establishing an initial estimate of resistance of an electrolytic solution RS₀, an initial estimate of impedance z₀, an initial estimate of voltage v₀, an initial estimate of capacitance of a coating of a piece of coated metal Cc₀, an initial estimate of a polarization resistance of an interface between the electrolytic solution and the piece of coated metal Rpo₀, an initial estimate of a charge transfer resistance at the interface between the electrolytic solution and the piece of coated metal Rct₀, and an initial estimate of double-layer capacitance at the interface between the electrolytic solution and the piece of coated metal Cdl₀; (b) setting an integer i equal to zero; (c) calculating an i-th estimate of the resistance of the electrolytic solution RSᵢ as

$${RS}_{i} = {RS}_{i - 1} + μ ( {v}_{i - 1} - {I}_{i - 1} {z}_{i - 1} ) {I}_{i} \cdot \frac{δ {z}_{i - 1}^{*}}{δ {RS}_{i - 1}} ,$$

where μ is a pre-set step size, vᵢ is an i-th estimate of voltage, I is an i-th estimate of current, and zᵢ is an i-th estimate of impedance (the symbol “*” represents the complex conjugate); (d) setting vᵢ₋₁ equal to a measured voltage across the coating and calculating an i-th estimate of the capacitance of the coating Ccᵢ as

$${Cc}_{i} = {Cc}_{i - 1} + μ ( {v}_{i - 1} - {I}_{i - 1} {z}_{i - 1} ) {I}_{i} \cdot \frac{δ {z}_{i - 1}^{*}}{δ {Cc}_{i - 1}} ;$$

(e) setting Iᵢ₋₁ equal to a current measured at the interface between the electrolytic solution and the piece of coated metal and calculating an i-th estimate of the polarization resistance of the interface between the electrolytic solution and the piece of coated metal Rpoᵢ as

$${Rpo}_{i} = {Rpo}_{i - 1} + μ ( {v}_{i - 1} - {I}_{i - 1} {z}_{i - 1} ) {I}_{i} \cdot \frac{δ {z}_{i - 1}^{*}}{δ {Rpo}_{i - 1}} ;$$

(f) setting vᵢ₋₁ equal to a voltage across a corroded portion at the interface between the electrolytic solution and the piece of coated metal and calculating an i-th estimate of the double-layer capacitance at the interface Cdlᵢ as

$${Cdl}_{i} = {Cdl}_{i - 1} + μ ( {v}_{i - 1} - {I}_{i - 1} {z}_{i - 1} ) {I}_{i} \cdot \frac{δ {z}_{i - 1}^{*}}{δ {Cdl}_{i - 1}} ;$$

(g) calculating an i-th estimate of the charge transfer resistance at the interface Rctᵢ as

$${Rct}_{i} = {Rct}_{i - 1} + μ ( {v}_{i - 1} - {I}_{i - 1} {z}_{i - 1} ) {I}_{i} \cdot \frac{δ {z}_{i - 1}^{*}}{δ {Rct}_{i - 1}} ;$$

(h) calculating an i-th estimate of a weight vector wᵢ as

$${w}_{i} = \frac{q}{{jCc}_{i} {Rpo}_{i}} [ {( \frac{δ z}{δ {Rpo}_{i}} )}^{- 2} - 1 ] ;$$

(i) calculating the i-th estimate of the impedance as

$${z}_{i} = {RS}_{i} + \frac{{Rct}_{i}}{1 + {jw}_{i} {Rct}_{i} {Cdl}_{i}} ;$$

and (j) if |zᵢ−zᵢ₋₁| is greater than a pre-set threshold, then setting i=i+1 and returning to step (c); otherwise, saving zᵢ in non-transitory computer readable memory and displaying zᵢ.

These and other features of the present invention will become readily apparent upon further review of the following specification.

### BRIEF DESCRIPTION OF THE DRAWINGS

FIG. 1 is a schematic diagram representing an equivalent circuit model of a coated piece of metal used as an example to illustrate the method for estimating impedance in electrochemical impedance spectroscopy according to the present invention.

FIG. 2 diagrammatically illustrates a conventional system model used in high order statistics (HOS) deconvolution according to the prior art.

FIG. 3 diagrammatically illustrates an elevation view in section of the coated piece of metal corresponding to the equivalent circuit of FIG. 1, shown with an overlay of the circuit elements of the equivalent circuit model.

FIG. 4 is a block diagram schematically illustrating an electrochemical impedance spectroscopy system with convolution of the data to eliminate noise.

FIG. 5 is a schematic diagram of a conventional Randles cell circuit model applied to a coated piece of metal, used as an example in the method for estimating impedance in electrochemical impedance spectroscopy according to the present invention.

FIG. 6 is a block diagram illustrating system components of a system for implementing the method for estimating impedance in electrochemical impedance spectroscopy according to the present invention.

Similar reference characters denote corresponding features consistently throughout the attached drawings.

### DETAILED DESCRIPTION OF THE PREFERRED EMBODIMENTS

The method for estimating impedance in electrochemical impedance spectroscopy is an iterative method, combining high order statistic (HOS) deconvolution and adaptive filtering (AF) to estimate impedance in electrochemical impedance spectroscopy for such applications as measuring the degree of electrolytic corrosion in a coated metal pipe, for example. High order statistics (HOS) deconvolution depends on a high order moment (i.e., a cumulant), which equals zero for Gaussian signals. Thus, HOS deconvolution can distinguish the nature of a particular process. The cumulant determines how close the distribution of a random process is from being a Gaussian distributed signal, and it is calculated as:

cₖⁿ(k₁,k₂, . . . ,kₙ₋₁)=mₙ^{x}(k₁,k₂, . . . ,kₙ₋₁)−mₙ^{G}(k₁,k₂, . . . ,kₙ₋₁), (1)

where mₙ^{x} is defined as the n-th order moment for a stationary random process, and is given by

mₙ^{x}(k₁,k₂, . . . ,kₙ₋₁)=E{x(k)x(k+k₁) . . . (k+kₙ₋₁)}, (2)

where E{ } represents the statistical expectation operator and mₙ^{G} is the n-th order moment for a Gaussian random process that has the same second-order statistics of the signal x. It should be noted that, for a Gaussian random process, the high order cumulants are identically zero.

For a random process whose mean equals zero, the first, second, third and fourth cumulants can be simplified to the following:

$$\{ \begin{matrix}{c}_{1}^{x} = {m}_{1}^{x} = 0 \\ {c}_{2}^{x} ( {k}_{1} ) = {m}_{2}^{x} ( {k}_{1} ) \\ {c}_{3}^{x} ( {k}_{1} , {k}_{2} ) = {m}_{3}^{x} ( {k}_{1} , {k}_{2} ) \\ {c}_{4}^{x} ( {k}_{1} , {k}_{2} , {k}_{3} ) = {m}_{4}^{x} ( {k}_{1} , {k}_{2} , {k}_{3} ) - {m}_{2}^{x} ( {k}_{1} ) {m}_{2}^{x} ( {k}_{3} - {k}_{2} ) \\ - {m}_{2}^{x} ( {k}_{2} ) {m}_{2}^{x} ( {k}_{3} - {k}_{1} ) \\ - {m}_{2}^{x} ( {k}_{3} ) {m}_{2}^{x} ( {k}_{3} - {k}_{1} ) .\end{matrix} \qquad ( 3 )$$

In HOS deconvolution, other measurements are used, including the n-th order spectrum and the n-th order cepstrum. The n-th order spectrum is the Fourier transform of the correlation function of a stationary random process. The second-order spectrum (the bi-spectrum) is given by C₃^{x}(w₁, w₂)=F₂ [c₃^{x}(k₁, k₂)], while the third-order spectrum (the tri-spectrum) is given by:

C₄^{x}(w₁,w₂,w₃)=F₃[C₄^{x}(k₁,k₂,k₃)]. (4)

The n-th order cepstrum is the inverse Fourier transform of the above equations. There are two HOS techniques for identifying the impulse response, namely, the parametric and the non-parametric approaches. For the parametric technique, the first step is to find the parameters of the nominator and denominator representing the Z-transform of the system frequency response. After that, the impulse response is obtained by taking the inverse Fourier transform of the estimated frequency response. The non-parametric method uses the cumulants, bi-cepstrum and tri-cepstrum to determine directly the impulse response of the system.

In HOS-based deconvolution, the tested system is usually assumed to be linear time invariant, causal and stable, with an absolutely summable impulse response. In addition, the input signal should be non-Gaussian, zero-mean, and independent and identically distributed (i.d.d.) with non-zero high order moments. Further, the input's noise and the output's noise are considered to be zero-mean, mutually correlated Gaussian random processes and independent of the input signal.

The last assumption is that the estimated model order satisfies the following inequalities:

$$\{ \begin{matrix}{n}_{a} \geq m \\ {n}_{b} \geq n ,\end{matrix} \qquad ( 5 )$$

where nₐ and n_{b} are, respectively, the estimated order of the dominator and nominator, and m and n are the true system order.

In HOS deconvolution, the system model is given by:

w(t)=Σᵢ₌₁ⁿ^{ₐ}Aᵢw(t−i)+Σᵢ₌₁ⁿ^{_{b}}Bᵢv(t−i), (6)

where w(t) and v(t) are, respectively, the output and input signals, and Aᵢ and Bᵢ are the unknown parameters of the system frequency response H(z):

$$H ( z ) = \frac{{B}_{3} {z}^{3} + {B}_{2} {z}^{2} + {B}_{1} z + … + {B}_{{n}_{b}}}{{A}_{3} {z}^{3} + {A}_{2} {z}^{2} + {A}_{1} z + … + {A}_{{n}_{a}}} . \qquad ( 7 )$$

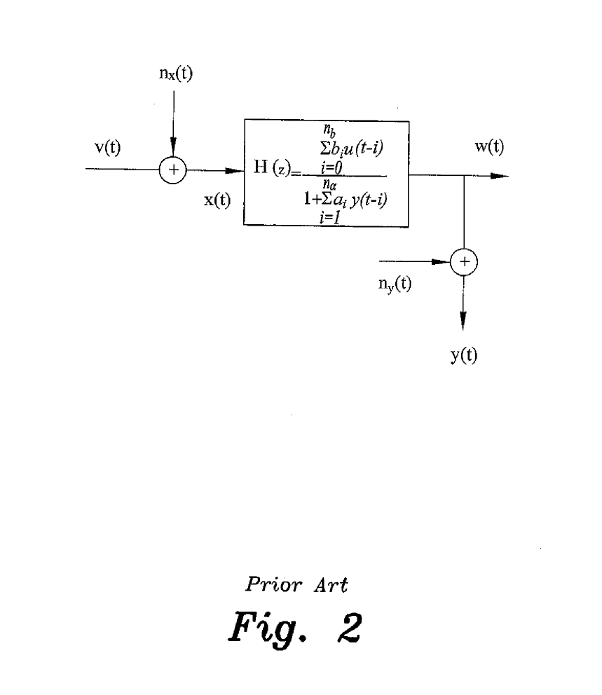

Usually, both the input and output are distorted by noise signals, resulting in the modified input and output signals:

$$\{ \begin{matrix}y ( t ) = w ( t ) + {n}_{y} ( t ) \\ x ( t ) = v ( t ) + {n}_{x} ( t ) ,\end{matrix} \qquad ( 8 )$$

where n_{y}(t) and nₓ(t) are, respectively, the output and input noise. This is illustrated in the system block diagram of FIG. 2.

As a result, the system model can be rewritten as:

y(t)+Σᵢ₌₁ⁿ^{ₐ}Aᵢy(t−i)=Σᵢ₌₁ⁿ^{_{b}}Bᵢx(t−i)+n(t), (9)

where

n(t)=Σᵢ₌₁ⁿ^{ₐ}Aᵢn_{y}(t−i)+Σᵢ₌₁ⁿ^{_{b}}Bᵢnₓ(t−i) (10)

The third-order cross-cumulants between the input and output signals are defined as follows:

c^{vwv}(τ₁,τ₂)=E[v(t)w(t+τ₁)v(t+τ₂)]. (11)

The cross-cumulants can be approximated from the sample average of both the input and output data as:

$${\hat{c}}^{vwv} ( {τ}_{1} , {τ}_{2} ) = \frac{1}{N} {\sum }_{t = 0}^{N - 1} [ v ( t ) w ( t + {τ}_{1} ) v ( t + {τ}_{2} ) ] , \qquad ( 12 )$$

where N equals the number of samples. The third-order cumulants-based deconvolution is based on several cumulant properties, including multilinearity (i.e., the cumulants are linear with respect to each of their arguments), additivity (i.e., the sum of the cumulants equals the cumulants of the sum), and the third-order cumulants of a random variable that has a symmetric distribution density function is zero.

Based on these properties, the impulse response of a linear system is written in terms of the auto- and cross-cumulants:

c^{vwv}(τ₁,τ₂)=Σ_{-∞}^{∞}h(t)c^{vvv}(τ¹−t,τ²), (13)

where h(t) is the system impulse response. Equation (13) can be rewritten using compact notation as:

$${c}^{vwv} ( {τ}_{1} , {τ}_{2} ) = \frac{B ( {q}^{- 1} )}{A ( {q}^{- 1} )} {c}^{vvv} ( {τ}_{1} - t , {τ}_{2} ) , \qquad ( 14 )$$

where q⁻¹ is the unit delay operator.

Using the noisy input and output signals (y(t), x(t)) instead of w(t) and v(t), an error signal e is generated:

e(τ₁,τ₂,θ)=A(q⁻¹)ĉ^{xyx}(τ₁,τ₂)−B(q⁻¹)ĉ^{xxx}(τ₁−t,τ₂), (15)

for θ=[a₁, . . . , aₙₐ, b₁, . . . , b_{nb}].

The objective of third-order cumulant-based deconvolution is to find the system parameters (i.e., the vector θ) by minimizing the cost function, which, in terms of the error signal e, is:

$$j ( θ , {τ}_{2} ) = \frac{1}{M} {\sum }_{{τ}_{1} = 1}^{M} {\frac{1}{2} [ e ( {τ}_{1} , {τ}_{2} , θ ) ]}^{2} . \qquad ( 16 )$$

In order to find the least square solution for the cost function of equation (16), the error signal is rewritten as:

$$\begin{matrix} e ( {τ}_{1} , {τ}_{2} , θ ) = {\hat{c}}^{xyx} ( {τ}_{1} , {τ}_{2} ) - {\hat{φ}}^{T} ( {τ}_{1} , {τ}_{2} ) θ , \\ where & ( 17 ) \\ \hat{φ} ( {τ}_{1} , {τ}_{2} ) = {[ \begin{matrix}- {\hat{c}}^{xyx} ( {τ}_{1} , {τ}_{2} ) , … , - {\hat{c}}^{xyx} ( {τ}_{1} - {n}_{a} , {τ}_{2} ) , {\hat{c}}^{xxx} ( {τ}_{1} - 1 , {τ}_{2} ) , … … , \\ {\hat{c}}^{xxx} ( {τ}_{1} - {n}_{b} , {τ}_{2} )\end{matrix} ]}^{T} . & ( 18 )\end{matrix}$$

For a specific value of τ₂ (e.g., τ₂=0), the least square algorithm yields the following solution:

$${\hat{θ}}^{M} = {[ \frac{1}{M} {\sum }_{{τ}_{1} = 1}^{M} \hat{φ} ( {τ}_{1} , {τ}_{2} ) {\hat{φ}}^{T} ( {τ}_{1} , {τ}_{2} ) ]}^{- 1} [ \frac{1}{M} {\sum }_{{τ}_{1} = 1}^{M} \hat{φ} ( {τ}_{1} , {τ}_{2} ) {\hat{c}}^{xyx} ( {τ}_{1} , {τ}_{2} ) ] . \qquad ( 19 )$$

The HOS deconvolution using third-order cumulants correctly estimates the impulse response of digital minimum phase systems (MPSs) and non-minimum phase systems (NMPSs). There are many factors that affect the accuracy of the estimation, such as the model assumed order (nₐ, n_{b}). If the difference of the assumed nominator and denominator orders is the same as for the true system, the estimation of the HOS-based deconvolution is perfect. Another factor that affects the deconvolution precision is the parameter M, which is used in the definition of the cost function, and is referred to as the “cumulants maximum lag”.

In the present method, the HOS-based EIS measurement is modeled as a convolution problem. The required impedance spectrum is assumed to be the unknown frequency response that can be estimated using a deconvolution filter. The inputs of the deconvolution filter are the arbitrary applied signal of the system, as well as the output signal. The main advantage of this approach is the ability to estimate the impedance spectrum (i.e., the system response) perfectly, even in the presence of noise, unlike an FFT-based method.

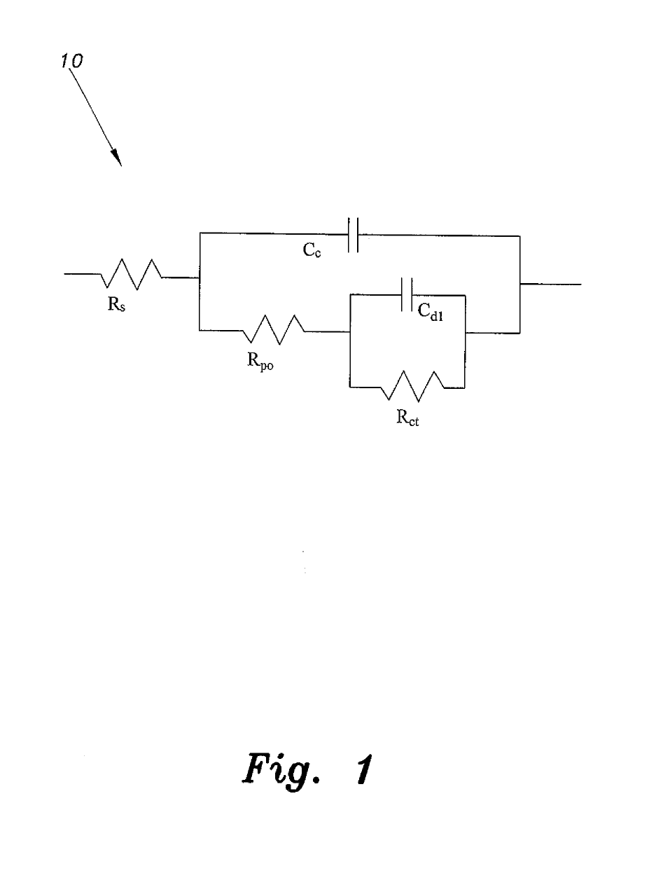

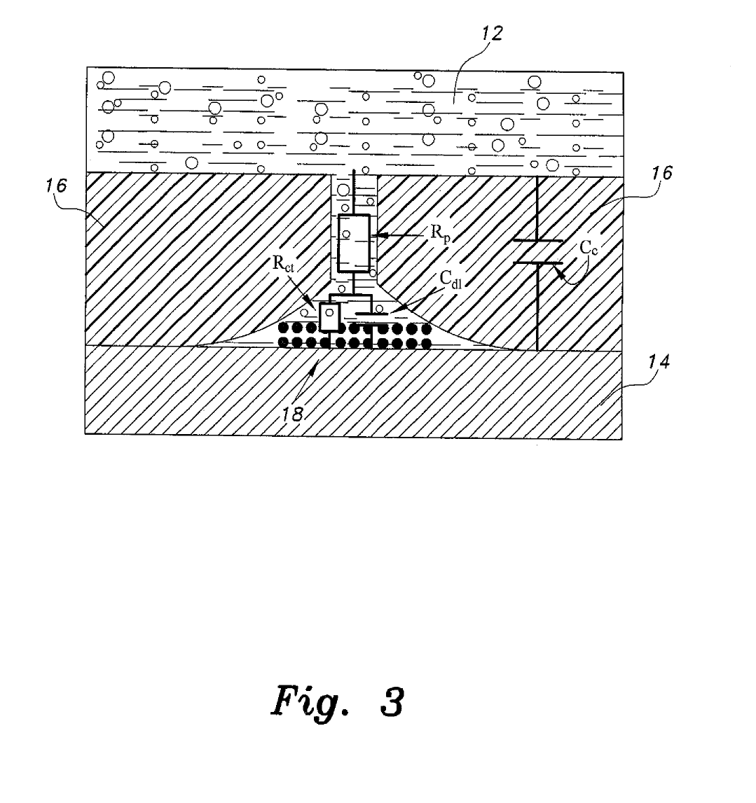

In a particular example, the electrochemical system is considered as a coated metal pipe, which can be represented by an electrical circuit model, such as the equivalent circuit 10 illustrated in FIG. 1. The circuit 10 generically represents a coated metal pipe. In FIG. 1, R_{S} represents the electrolyte resistance, Rₚₒ represents the polarization resistance, C^{c} represents the coating capacitance, R_{ct} is the charge transfer resistance (which is inversely proportional to the corrosion rate), and C_{dl} is the double layer capacitance at the electrode-electrolyte interface. Typically, the value of the model's parameters change during the life of the coating, such that Rₚₒ, R_{ct} and C_{dl} do not exist when the coating is new. While R_{ct} and C_{dl} are non-zero as soon as the corrosions starts, the C_{c} and Rₚₒ become zero when the coating breaks up. FIG. 3 illustrates how the generic circuit 10 of FIG. 1 may be used to model EIS measurement in a coated pipe, where the pipe metal 14 is coated with coating 16. Undercoating corrosion is generally designated as 18, and the electrolyte is generally designated as 12.

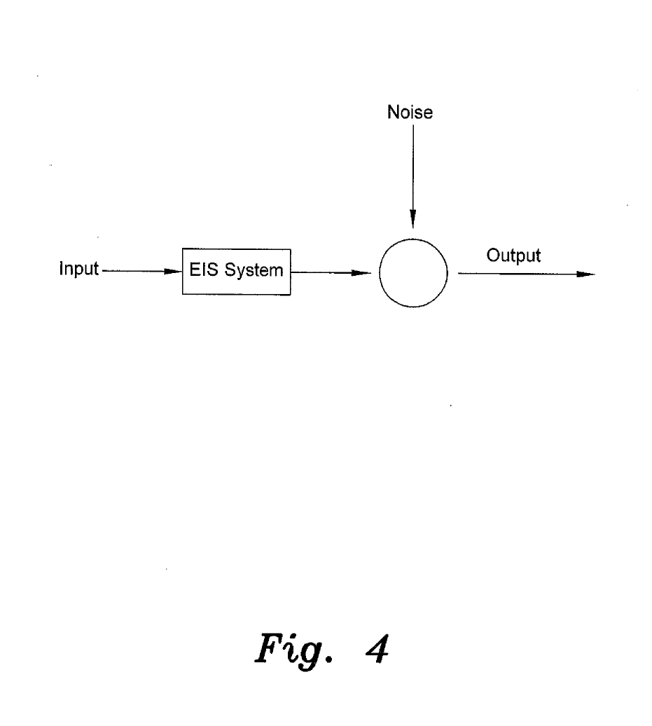

FIG. 4 diagrammatically illustrates how the EIS measurement of the electrochemical system (i.e., the coated metal of FIG. 3) is modeled as a convolution problem. In this convolution model, the input signal is either a current (galvonostatic mode) or a voltage (potentiostatic mode) signal. Additionally, the input and output signals are distorted by noise signals generated by different probability density functions (Gaussian, uniform and Rayleigh). The mathematical expression of this model is given as:

y(t)=i(t) [symbol] Z(t)+n(t), (20)

where Z(t) is the inverse Fourier transform of the impedance spectrum Z(w), and n(t) is the noise. Once the Z(w) is estimated, a curve-fitting technique is used to estimate the electrical circuit's parameters based on the complex nonlinear least squares method (CNLS). The goal of the CNLS is to find a set of parameters P that will decrease the following cost function:

S(P)=Σ_{M}Wⱼ[Yⱼ−YCⱼ(P)]², (21)

where M is the number of individual measurement data, Wⱼ is the weight associated with the j-th observation point Yⱼ, and YCⱼ(P) is a function in terms of the parameters P, whose curve tracks the observation's curve. This technique can handle complex data by splitting the real and imaginary parts in a single array, which double the data point's number from M to 2M.

The original objective of third-order cumulants deconvolution is to estimate the impulse response of the linear time-invariant (LTI) system. However, EIS aims to find the impedance spectrum of continuous electrochemical systems, rather than the impulse response. There are two approaches to find the impedance spectrum using the HOS-based method. In the first approach, the Fast Fourier transform is utilized to convert the estimated impulse response to the required frequency response. However, this approach will not estimate the amplitude of the spectrum as perfectly as the phase side. The amplitude of the estimated impedance spectrum needs to be amplified to match the true impedance. The second approach is to find the impedance spectrum from the estimated Z-transform of the equivalent digital system directly, rather than the estimated impulse response. The continuous transfer function (i.e., the Laplace transform) is obtained by converting the transfer function from the Z-domain to the S-domain using conventional methods, such as zero-order hold, first-order hold, Tustin approximation, and matched poles and zeros methods. As a result, the use of the Fast Fourier Transform (FFT) is avoided. The FFT of a digital signal is defined as follows:

X(K)=Σₙ₌₁^{N}x(n)e^{-2πj(K-1)(n-1)/N}, (22)

where N is the length of the digital sequence. The precision and the speed of the FFT calculation depends on the length of the signal N. When the signal is padded with zeroes, the accuracy of the FFT increases. In addition, the final result of the FFT needs to be normalized with the signal's length N. Thus, the length N could affect the accuracy of the estimated impedance spectrum and this could cause amplitude estimation errors. Thus, we seek to avoid the use of the FFT by taking the second approach.

At this stage, we now move to the second step in the EIS, which is finding the circuit model's parameters. The CNLS estimates the circuit parameters using curve fitting of the EIS data produced either by FFT or FRA. We can now find directly the circuit parameters in a noisy environment by a single step. This is achieved using a suitable adaptive filtering technique with a proper cost function in terms of the current and voltage across the tested system, as will be described in detail below.

In the case of the HOS deconvolution, the electrochemical system's components are obtained indirectly. The frequency response is measured, followed by the estimation of the components using the curve-fitting techniques. On the other hand, using different adaptive filtering techniques, such as least square and steepest descent, can give a direct estimation of the system's components. This can be accomplished by building the cost function in terms of the circuit's parameters, namely, R_{S}, Rₚₒ, R_{ct}, C_{c} and C_{dl}. As will be described below in greater detail, a combination of least square and steepest descent adaptive filtering is used in the present method.

Adaptive filters are systems that react to variations in their environment by adapting their internal structure in order to meet certain performance specifications. This is considered to be an optimization tool that can be used to estimate specific variables in a noisy environment, Adaptive filtering systems are widely used in communications, signal processing, and control.

A primary application of adaptive filtering (AF) is channel estimation, in which channel properties are defined in term of fading, scattering and power attenuation. The main objective of electrochemical impedance spectroscopy is to determine the impedance spectrum, which may also be treated as a channel. Thus, we may apply adaptive filtering techniques in order to estimate the impedance spectrum. The two main AF techniques used in the present method, namely, least squares and steepest descent, are briefly described below.

In the least squares technique, if there is an n×1 vector y and an n×m observation matrix H, the least squares problem looks for an m×1 weight vector w that solves the following cost function:

min_{w}∥y−Hw∥². (23)

The solution of cost function (23) (i.e., the weight vector w) is unique if and only if the column data matrix H is linearly independent. This requires that the number of rows be greater than or equal to the number of columns (i.e., n≧m). By validating this condition, the weight vector is given by:

w=(H*H)⁻¹H*y. (24)

In some cases, there are many solutions for the vector w when the product H*H is singular.

The steepest descent (SD) method approximates the optimal solution of a linear estimator in an iterative manner. SD is used when the optimal solution of a linear estimation problem cannot be described in closed form. Considering a zero-mean random variable d with variance σ_{d}², a zero-mean random row vector u, and a correlation matrix Rᵤ=Eu*u>0, the solution of a linear least squares estimation problem min_{w}E∥d−uw∥² is given by the weight vector w=Rᵤ⁻¹R_{du}. In this case, the cost function is quadratic in w, and it has a global minimum at w₀. However, in some cases, the correlation matrix Rᵤ is not invertible, and thus there is no closed form solution. The SD method can determine the optimal solution w recursively with initial guess w₋₁ as:

wᵢ=wᵢ₋₁μp, (25)

for i≧0, where μ is the step size and p is the update direction vector, which equals the gradient of the cost function with respect to the weight vector:

p=−B[∇_{∇w}J(wᵢ₋₁)]^{*} (26)

J(w)=E|d−uw|². (27)

In order to successfully estimate the weight vector w, the value of the step size pt should be in the region 0<μ<λₘₐₓ, where λₘₐₓ is the maximum eigenvalue of the correlation matrix Rᵤ. Additionally, to ensure the fastest convergence of the solution, the step size μ should equal

$$\frac{2}{{λ}_{max} + {λ}_{min}} ,$$

where λₘᵢₙ represents the smallest eigenvalue of the correlation matrix Rᵤ.

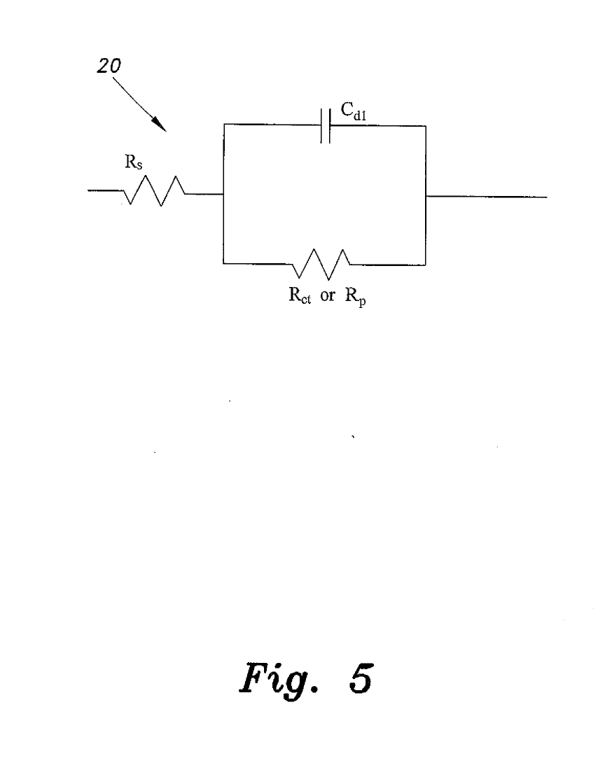

Using adaptive filtering, the coated metal of FIG. 3 can be modeled by the well-known Randles cell circuit 20, as illustrated in FIG. 5. The circuit 20 includes a solution resistance R_{S}, a double layer capacitor C_{dl}, and either a charge transfer resistance R_{ct} or polarization resistance Rₚₒ. For the Randles cell circuit, the equivalent circuit impedance is not a linear combination of the parameters. Thus, the least squares method cannot be utilized. The steepest descent method, however, can be used with a cost function of:

J(Z)=E|V−IZ|², (28)

where Z is the required impedance, V is the Z-transform of the voltage signal, and I is the Z-transform of the current signal.

The solution of the cost function (28) is the recursive equation (25), and the weight vector is a function of the circuit's parameters. In order to find the update direction vector P, a partial gradient of the cost function is calculated with respect to the circuit parameters as follows:

$$\begin{matrix}P = - {[ {∇}_{R 1 , R 2 , C 1} J ( {v}_{i - 1} - {I}_{i - 1} {z}_{i - 1} ) ]}^{*} & ( 29 ) \\ [ \begin{matrix}\frac{δ J}{δ e} & \frac{δ e}{δ z} & \frac{δ z}{δ R 1} \\ \frac{δ J}{δ e} & \frac{δ e}{δ z} & \frac{δ z}{δ R 2} \\ \frac{δ J}{δ e} & \frac{δ e}{δ z} & \frac{δ z}{δ C 1}\end{matrix} ] & ( 30 ) \\ \frac{δ J}{δ e} = {Le}^{*} {\vert e \vert}^{2 ( L - 1 )} = {e}^{*} , & ( 31 )\end{matrix}$$

where L=1 for the mean square error optimization, and the error e equals the cost function (28):

$$\begin{matrix}\frac{δ z}{δ R 1} = 1 & ( 32 ) \\ \frac{δ e}{δ z} = - I & ( 33 ) \\ \frac{δ z}{δ R 2} = \frac{1}{{( 1 + j wC 1 R 2 )}^{2}} & ( 34 ) \\ \frac{δ z}{δ C 1} = - \frac{{j ( R 2 )}^{2}}{{( 1 + j wC 1 R 2 )}^{2}} . & ( 35 )\end{matrix}$$

Thus, the following recursion equation estimates the circuit parameters R1, R2 and C1:

$$[ \begin{matrix}R {1}_{i} \\ R {2}_{i} \\ C {1}_{i}\end{matrix} ] = [ \begin{matrix}R {1}_{i - 1} \\ R {2}_{i - 1} \\ C {1}_{i - 1}\end{matrix} ] + μ ( {V}_{i - 1} - {I}_{i - 1} {Z}_{i - 1} ) {I}_{i - 1}^{*} [ \begin{matrix}\frac{δ {z}_{i - 1}}{δ R {1}_{i - 1}} \\ \frac{δ {z}_{i - 1}}{δ R {2}_{i - 1}} \\ \frac{δ {z}_{i - 1}}{δ C {1}_{i - 1}}\end{matrix} ] . \qquad ( 36 )$$

The parameters of the circuit representing the coated metal of FIG. 3 are estimated by the same SD algorithm used from the Randles cell model. The recursion equation estimates the circuit parameters of the coated metal as:

$$[ \begin{matrix}{RS}_{i} \\ {Rpo}_{i} \\ {Rct}_{i} \\ {Cc}_{i} \\ {Cdl}_{i}\end{matrix} ] = [ \begin{matrix}{RS}_{i - 1} \\ {Rpo}_{i - 1} \\ {Rct}_{i - 1} \\ {Cc}_{i - 1} \\ {Cdl}_{i - 1}\end{matrix} ] + μ ( {v}_{i - 1} - {I}_{i - 1} {z}_{i - 1} ) {I}_{i} [ \begin{matrix}\frac{δ {z}_{i - 1}^{*}}{δ {RS}_{i - 1}} \\ \frac{δ {z}_{i - 1}^{*}}{δ {Rpo}_{i - 1}} \\ \frac{δ {z}_{i - 1}^{*}}{δ {Rct}_{i - 1}} \\ \frac{δ {z}_{i - 1}^{*}}{δ {Cc}_{i - 1}} \\ \frac{δ {z}_{i - 1}^{*}}{δ {Cdl}_{i - 1}}\end{matrix} ] . \qquad ( 37 )$$

Thus, in order to estimate the impedance of the coated metal of FIG. 3, the following method is utilized: (a) establishing an initial estimate of resistance of an electrolytic solution RS₀, an initial estimate of impedance z₀, an initial estimate of voltage v₀, an initial estimate of capacitance of a coating of a piece of coated metal Cc₀, an initial estimate of a polarization resistance of an interface between the electrolytic solution and the piece of coated metal Rpo₀, an initial estimate of a charge transfer resistance at the interface between the electrolytic solution and the piece of coated metal Rct₀, and an initial estimate of double-layer capacitance at the interface between the electrolytic solution and the piece of coated metal Cdl₀; (b) setting an integer I equal to zero; (c) calculating an i-th estimate of the resistance of the electrolytic solution RSᵢ as

$${RS}_{i} = {RS}_{i - 1} + μ ( {v}_{i - 1} - {I}_{i - 1} {z}_{i - 1} ) {I}_{i} \cdot \frac{δ {z}_{i - 1}^{*}}{δ {RS}_{i - 1}} ,$$

where μ is a pre-set step size, vᵢ is an i-th estimate of voltage, I is an i-th estimate of current, and zᵢ is an i-th estimate of impedance (the symbol “*” represents the complex conjugate); (d) setting vᵢ₋₁ equal to a measured voltage across the coating and calculating an i-th estimate of the capacitance of the coating Ccᵢ as

$${Cc}_{i} = {Cc}_{i - 1} + μ ( {v}_{i - 1} - {I}_{i - 1} {z}_{i - 1} ) {I}_{i} \cdot \frac{δ {z}_{i - 1}^{*}}{δ {Cc}_{i - 1}} ;$$

(e) setting Iᵢ₋₁ equal to a current measured at the interface between the electrolytic solution and the piece of coated metal and calculating an i-th estimate of the polarization resistance of the interface between the electrolytic solution and the piece of coated metal Rpoᵢ as

$${Rpo}_{i} = {Rpo}_{i - 1} + μ ( {v}_{i - 1} - {I}_{i - 1} {z}_{i - 1} ) {I}_{i} \cdot \frac{δ {z}_{i - 1}^{*}}{δ {Rpo}_{i - 1}} ;$$

(f) setting vᵢ₋₁ equal to a voltage across a corroded portion at the interface between the electrolytic solution and the piece of coated metal and calculating an estimate of the double-layer capacitance at the interface Cdlᵢ as

$${Cdl}_{i} = {Cdl}_{i - 1} + μ ( {v}_{i - 1} - {I}_{i - 1} {z}_{i - 1} ) {I}_{i} \cdot \frac{δ {z}_{i - 1}^{*}}{δ {Cdl}_{i - 1}} ;$$

(g) calculating an i-th estimate of the charge transfer

$${Rct}_{i} = {Rct}_{i - 1} + μ ( {v}_{i - 1} - {I}_{i - 1} {z}_{i - 1} ) {i}_{i} \cdot \frac{δ {z}_{i - 1}^{*}}{δ {Rct}_{i - 1}} ;$$

resistance at the interface Rctᵢ as
(h) calculating an i-th estimate of a weight vector wᵢ as

$${w}_{i} = \frac{q}{{jCc}_{i} {Rpo}_{i}} [ {( \frac{δ z}{δ {Rpo}_{i}} )}^{- 2} - 1 ] ,$$

where “j” represents the imaginary unit; (i) calculating the i-th estimate of the impedance as

$${z}_{i} = {RS}_{i} + \frac{{Rct}_{i}}{1 + {jw}_{i} {Rct}_{i} {Cdl}_{i}} ;$$

and (j) if |zᵢ−zᵢ₋₁| is greater than a pre-set threshold, then setting i=i+1 and returning to step (c); otherwise, saving zᵢ in non-transitory computer readable memory and displaying zᵢ.

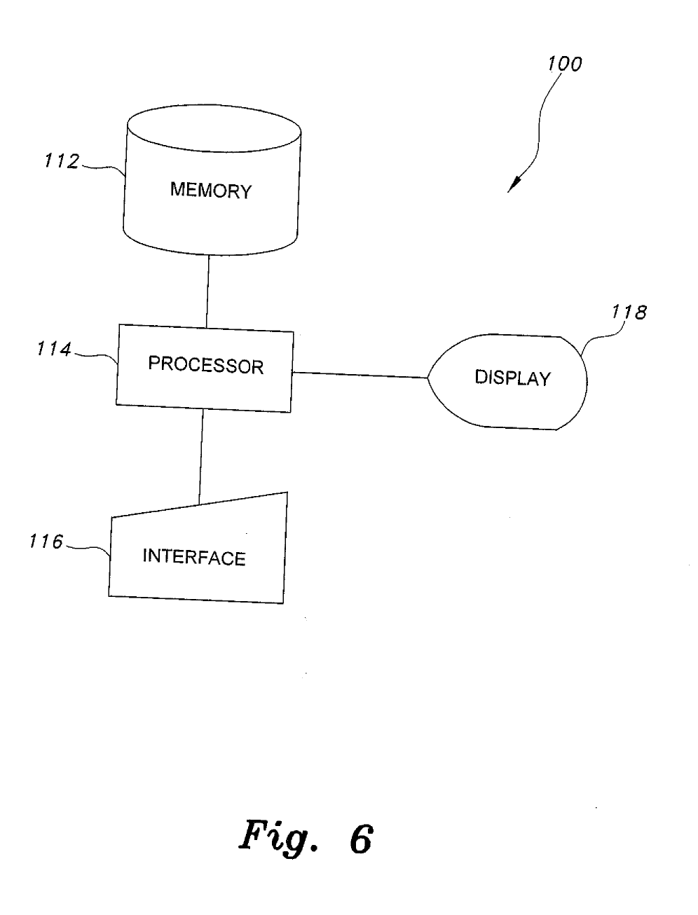

FIG. 6 illustrates a generalized system 100 for implementing the above method, although it should be understood that the generalized system 100 may represent a stand-alone computer, computer terminal, portable computing device, networked computer or computer terminal, or networked portable device. Data may be entered into the system 100 by the user via any suitable type of user interface 116, and may be stored in computer readable memory 112, which may be any suitable type of computer readable and programmable memory. Calculations are performed by the processor 114, which may be any suitable type of computer processor, and may be displayed to the user on the display 118, which may be any suitable type of computer display.

The processor 114 may be associated with, or incorporated into, any suitable type of computing device, for example, a personal computer or a programmable logic controller. The display 118, the processor 114, the memory 112, and the user interface 116 and any associated computer readable media are in communication with one another by any suitable type of data bus, as is well known in the art.

Examples of computer readable media include non-transitory computer readable memory, a magnetic recording apparatus, an optical disk, a magneto-optical disk, and/or a semiconductor memory (for example, RAM, ROM, etc.). Examples of magnetic recording apparatus that may be used in addition to memory 112, or in place of memory 112, include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW.

It is to be understood that the present invention is not limited to the embodiments described above, but encompasses any and all embodiments within the scope of the following claims.

We claim:

1. A method for estimating impedance in electrochemical impedance spectroscopy, comprising the steps of:
(a) establishing an initial estimate of resistance of an electrolytic solution RS₀, an initial estimate of impedance z₀, an initial estimate of voltage v₀, an initial estimate of capacitance of a coating of a piece of coated metal Cc₀, an initial estimate of a polarization resistance of an interface between the electrolytic solution and the piece of coated metal Rpo₀, an initial estimate of a charge transfer resistance at the interface between the electrolytic solution and the piece of coated metal Rct₀, and an initial estimate of double-layer capacitance at the interface between the electrolytic solution and the piece of coated metal Cdl₀;
(b) setting an integer i equal to zero;
(c) calculating an i-th estimate of the resistance of the electrolytic solution RSᵢ as
$${RS}_{i} = {RS}_{i - 1} + μ ( {v}_{i - 1} - {I}_{i - 1} {z}_{i - 1} ) {I}_{i} \cdot \frac{δ {z}_{i - 1}^{*}}{δ {RS}_{i - 1}} ,$$
where μ is a pre-set step size, vₜ is an i-th estimate of voltage, I is an i-th estimate of current, and zᵢ is an i-th estimate of impedance;
(d) setting vᵢ₋₁ equal to a measured voltage across the coating and calculating an i-th estimate of the capacitance of the coating Ccᵢ as
$${Cc}_{i} = {Cc}_{i - 1} + μ ( {v}_{i - 1} - {I}_{i - 1} {z}_{i - 1} ) {I}_{i} \cdot \frac{δ {z}_{i - 1}^{*}}{{δCc}_{i - 1}} ;$$
(e) setting Iᵢ₋₁ equal to a current measured at the interface between the electrolytic solution and the piece of coated metal and calculating an i-th estimate of the polarization resistance of the interface between the electrolytic solution and the piece of coated metal Rpoᵢ as
$${Rpo}_{i} = {Rpo}_{i - 1} + μ ( {v}_{i - 1} - {I}_{i - 1} {z}_{i - 1} ) {I}_{i} \cdot \frac{δ {z}_{i - 1}^{*}}{δ {Rpo}_{i - 1}} ;$$
(f) setting vᵢ₋₁ equal to a voltage across a corroded portion at the interface between the electrolytic solution and the piece of coated metal and calculating an i-th estimate of the double-layer capacitance at the interface Cdlᵢ as
$${Cdl}_{i} = {Cdl}_{i - 1} + μ ( {v}_{i - 1} - {I}_{i - 1} {z}_{i - 1} ) {I}_{i} \cdot \frac{δ {z}_{i - 1}^{*}}{δ {Cdl}_{i - 1}} ;$$
(g) calculating an i-th estimate of the charge transfer resistance at the interface Rctᵢ as
$${Rct}_{i} = {Rct}_{i - 1} + μ ( {v}_{i - 1} - {I}_{i - 1} {z}_{i - 1} ) {I}_{i} \cdot \frac{δ {z}_{i - 1}^{*}}{δ {Rct}_{i - 1}} ;$$
(h) calculating an i-th estimate of a weight vector wᵢ as
$${w}_{i} = \frac{q}{{jCc}_{i} {Rpo}_{i}} [ {( \frac{δ z}{δ {Rpo}_{i}} )}^{- 2} - 1 ] ;$$
(i) calculating the i-th estimate of the impedance as
$${z}_{i} = {RS}_{i} + \frac{{Rct}_{i}}{1 + j {w}_{i} {Rct}_{i} {Cdl}_{i}} ;$$
and
(j) if |zᵢ−zᵢ₋₁| is greater than a pre-set threshold, then setting i=i+1 and returning to step (c); otherwise, saving zᵢ in non-transitory computer readable memory and displaying zᵢ.

2. A system for estimating impedance in electrochemical impedance spectroscopy, comprising:
a processor;
computer readable memory coupled to the processor;
a user interface coupled to the processor;
a display coupled to the processor;
software stored in the memory and executable by the processor, the software having:
means for calculating an i-th estimate of the resistance of the electrolytic solution RSᵢ as
$${RS}_{i} = {RS}_{i - 1} + μ ( {v}_{i - 1} - {I}_{i - 1} {z}_{i - 1} ) {I}_{i} \cdot \frac{δ {z}_{i - 1}^{*}}{δ {RS}_{i - 1}} ,$$
where μ is a pre-set step size, vᵢ is an i-th estimate of voltage, I is an i-th estimate of current, and zᵢ is an i-th estimate of impedance;
means for setting vᵢ₋₁ equal to a measured voltage across the coating and calculating an i-th estimate of the capacitance of the coating Ccᵢ as
$${Cc}_{i} = {Cc}_{i - 1} + μ ( {v}_{i - 1} - {I}_{i - 1} {z}_{i - 1} ) {I}_{i} \cdot \frac{δ {z}_{i - 1}^{*}}{δ {Cc}_{i - 1}} ;$$
means for setting Iᵢ₋₁ equal to a current measured at the interface between the electrolytic solution and the piece of coated metal and calculating an i-th estimate of the polarization resistance of the interface between the electrolytic solution and the piece of coated metal Rpoᵢ as
$${Rpo}_{i} = {Rpo}_{i - 1} + μ ( {v}_{i - 1} - {I}_{i - 1} {z}_{i - 1} ) {I}_{i} \cdot \frac{δ {z}_{i - 1}^{*}}{δ {Rpo}_{i - 1}} ;$$
means for setting vᵢ₋₁ equal to a voltage across a corroded portion at the interface between the electrolytic solution and the piece of coated metal and calculating an i-th estimate of the double-layer capacitance at the interface Cdlᵢ as
$${Cdl}_{i} = {Cdl}_{i - 1} + μ ( {v}_{i - 1} - {I}_{i - 1} {z}_{i - 1} ) {I}_{i} \cdot \frac{δ {z}_{i - 1}^{*}}{δ {Cdl}_{i - 1}} ;$$
means for calculating an i-th estimate of the charge transfer resistance at the interface Rctᵢ as
$${Rct}_{i} = {Rct}_{i - 1} + μ ( {v}_{i - 1} - {I}_{i - 1} {z}_{i - 1} ) {I}_{i} \cdot \frac{δ {z}_{i - 1}^{*}}{δ {Rct}_{i - 1}} ;$$
means for calculating an i-th estimate of a weight vector wᵢ as
$${w}_{i} = \frac{q}{{jCc}_{i} {Rpo}_{i}} [ {( \frac{δ z}{δ {Rpo}_{i}} )}^{- 2} - 1 ] ;$$
and
means for calculating the i-th estimate of the impedance as
$${z}_{i} = {RS}_{i} + \frac{{Rct}_{i}}{1 + j {w}_{i} {Rct}_{i} {Cdl}_{i}} .$$

3. A computer software product that includes a non-transitory storage medium readable by a processor, the non-transitory storage medium having stored thereon a set of instructions for performing estimation of impedance in electrochemical impedance spectroscopy, the instructions comprising:
(a) a first set of instructions which, when loaded into main memory and executed by the processor, causes the processor to establish an initial estimate of resistance of an electrolytic solution RS₀, an initial estimate of impedance z₀, an initial estimate of voltage v₀, an initial estimate of capacitance of a coating of a piece of coated metal Cc₀, an initial estimate of a polarization resistance of an interface between the electrolytic solution and the piece of coated metal Rpo₀, an initial estimate of a charge transfer resistance at the interface between the electrolytic solution and the piece of coated metal Rct₀, and an initial estimate of double-layer capacitance at the interface between the electrolytic solution and the piece of coated metal Cdl₀;
(b) a second set of instructions which, when loaded into main memory and executed by the processor, causes the processor to set an integer i equal to zero;
(c) a third set of instructions which, when loaded into main memory and executed by the processor, causes the processor to calculate an i-th estimate of the resistance of the electrolytic solution RSᵢ as
$${RS}_{i} = {RS}_{i - 1} + μ ( {v}_{i - 1} - {I}_{i - 1} {z}_{i - 1} ) {I}_{i} \cdot \frac{δ {z}_{i - 1}^{*}}{δ {RS}_{i - 1}} ,$$
where μ is a pre-set step size, vᵢ is an i-th estimate of voltage, I is an i-th estimate of current, and zᵢ is an i-th estimate of impedance;
(d) a fourth set of instructions which, when loaded into main memory and executed by the processor, causes the processor to set vᵢ₋₁ equal to a measured voltage across the coating and calculate an i-th estimate of the capacitance of the coating Ccᵢ as
$${Cc}_{i} = {Cc}_{i - 1} + μ ( {v}_{i - 1} - {I}_{i - 1} {z}_{i - 1} ) {I}_{i} \cdot \frac{δ {z}_{i - 1}^{*}}{δ {Cc}_{i - 1}} ;$$
(e) a fifth set of instructions which, when loaded into main memory and executed by the processor, causes the processor to set Iᵢ₋₁ equal to a current measured at the interface between the electrolytic solution and the piece of coated metal and calculate an i-th estimate of the polarization resistance of the interface between the electrolytic solution and the piece of coated metal Rpoᵢ as
$${Rpo}_{i} = {Rpo}_{i - 1} + μ ( {v}_{i - 1} - {I}_{i - 1} {z}_{i - 1} ) {I}_{i} \cdot \frac{δ {z}_{i - 1}^{*}}{δ {Rpo}_{i - 1}} ;$$
(f) a sixth set of instructions which, when loaded into main memory and executed by the processor, causes the processor to set vᵢ₋₁ equal to a voltage across a corroded portion at the interface between the electrolytic solution and the piece of coated metal and calculate an i-th estimate of the double-layer capacitance at the interface Cdlᵢ as
$${Cdl}_{i} = {Cdl}_{i - 1} + μ ( {v}_{i - 1} - {I}_{i - 1} {z}_{i - 1} ) {I}_{i} \cdot \frac{δ {z}_{i - 1}^{*}}{δ {Cdl}_{i - 1}} ;$$
(g) a seventh set of instructions which, when loaded into main memory and executed by the processor, causes the processor to calculate an i-th estimate of the charge transfer resistance at the interface Rctᵢ as
$${Rct}_{i} = {Rct}_{i - 1} + μ ( {v}_{i - 1} - {I}_{i - 1} {z}_{i - 1} ) {I}_{i} \cdot \frac{δ {z}_{i - 1}^{*}}{δ {Rct}_{i - 1}} ;$$
(h) an eighth set of instructions which, when loaded into main memory and executed by the processor, causes the processor to calculate an i-th estimate of a weight vector wᵢ as
$${w}_{i} = \frac{q}{j {Cc}_{i} {Rpo}_{i}} [ {( \frac{δ z}{δ {Rpo}_{i}} )}^{- 2} - 1 ] ;$$
(i) a ninth set of instructions which, when loaded into main memory and executed by the processor, causes the processor to calculate the i-th estimate of the impedance as
$${z}_{i} = {RS}_{i} + \frac{{Rct}_{i}}{1 + j {w}_{i} {Rct}_{i} {Cdl}_{i}} ;$$
and
(j) a tenth set of instructions which, when loaded into main memory and executed by the processor, causes the processor to set i=i+1 and return to the third set of instructions if |zᵢ−zᵢ₋₁| is greater than a pre-set threshold, otherwise saving zᵢ in the non-transitory storage medium and displaying zᵢ.
